(19) United States
(12) Patent Application Publication
(10) Pub. No.: US 2024/0160709 A1
(43) Pub. Date: May 16, 2024

(54) AUTHENTICATION MANAGEMENT DEVICE, AUTHENTICATION METHOD, AND RECORDING MEDIUM

(71) Applicants: NEC Corporation, Minato-ku, Tokyo (JP); NEC Platforms, Ltd., Kawasaki-shi, Kanagawa (JP)

(72) Inventor: Ryoji MIYAHARA, Kanagawa (JP)

(73) Assignees: NEC Corporation, Minato-ku, Tokyo (JP); NEC Platforms, Ltd., Kawasaki-shi, Kanagawa (JP)

(21) Appl. No.: 18/282,740

(22) PCT Filed: Mar. 18, 2021
(86) PCT No.: PCT/JP2021/011098

§ 371 Date: Sep. 18, 2023

(51) Int. Cl. G06F 21/32; H04R 1/10

(52) U.S. Cl. CPC G06F 21/32; H04R 1/1016

(57) ABSTRACT

An authentication management device acquires a result of authenticating a user by otoacoustic authentication in an earphone; stores the authentication result; after the authentication result is acquired, acquires a wearing determination result indicating whether the earphone is worn in an ear of the user on the basis of a detection result of a proximity sensor; and updates the stored authentication result when the wearing determination result indicates that the earphone is not worn in the ear.

### TECHNICAL FIELD

The present disclosure relates to an authentication management device, an authentication method, and a recording medium.

### BACKGROUND ART

In Patent Document 1, an invention is described in which earphones are operated in three modes: a first operation mode, a second operation mode, and a third operation mode, in order to reduce power consumption in a wearable device that performs biometric authentication based on an acoustic characteristic.

### PRIOR ART DOCUMENTS

### Patent Documents

Patent Document 1: PCT International Publication No. WO2020/129198

### SUMMARY OF THE INVENTION

### Problems to be Solved by the Invention

In the invention described in Patent Document 1, the method of controlling the authentication state is not disclosed.

In view of the above circumstances, an example object of the present disclosure is to provide an authentication management device, an authentication method, and a recording medium that solve the above problem.

### Means for Solving the Problem

One example aspect of the present disclosure is an authentication management device provided with an authentication result acquisition means that acquires a result of authenticating a user by otoacoustic authentication in an earphone; a storage means that stores the authentication result; a determination result acquisition means that, after the authentication result is acquired, acquires a wearing determination result indicating whether the earphone is worn in an ear of the user on the basis of a detection result of a proximity sensor; and a control means that updates the authentication result stored in the storage means when the wearing determination result indicates that the earphone is not worn in the ear.

### BRIEF DESCRIPTION OF THE DRAWINGS

FIG. 1 is a drawing that shows an example of the configuration of the authentication system S in the first example embodiment.

FIG. 2 is a block drawing that shows the hardware configuration of the information communication device 1 in the first example embodiment.

FIG. 3 is a block drawing that shows the hardware configuration of the earphone 2 in the first example embodiment.

FIG. 4 is a block drawing that shows the hardware configuration of the earphone control device 20 in the first example embodiment.

FIG. 5 is a functional block drawing of the information communication device 1, the earphone control device 20R, and the earphone control device 20L in the first example embodiment.

FIG. 6 is a flowchart that shows the process flow of the authentication system S in the first example embodiment.

FIG. 7 is a flowchart that shows the process flow of the authentication system S in the second example embodiment.

FIG. 8 is a flowchart that shows the process flow of the authentication system S in the third example embodiment.

FIG. 9 is a functional block diagram of the earphone 2C in the fourth example embodiment.

FIG. 10 is a flowchart of the process flow of the authentication system S in the fourth example embodiment.

FIG. 11 is a block drawing that shows the hardware configuration of the earphone 2D in the fifth example embodiment.

FIG. 12 is a block drawing that shows the hardware configuration of the earphone control device 20D in the fifth example embodiment.

FIG. 13 is a flowchart for setting the monitor cycle in the fifth example embodiment.

FIG. 14 is a graph showing the time transition of sensor information in the fifth example embodiment.

FIG. 15 is a drawing that shows the minimum configuration of the authentication system S in the present disclosure.

FIG. 16 is a flowchart that shows the process flow in the example embodiment of the minimum configuration of the authentication system S in the present disclosure.

### EXAMPLE EMBODIMENT

Example embodiments are described in detail below with reference to the accompanying drawings. The following example embodiments are not intended to limit the scope of the claims, and not all of the combinations of features described in the example embodiments are essential to the invention. Two or more of the plurality of features described in the example embodiments may be optionally combined. The same reference numerals are used for identical or similar configurations, and redundant explanations are omitted.

### First Example Embodiment

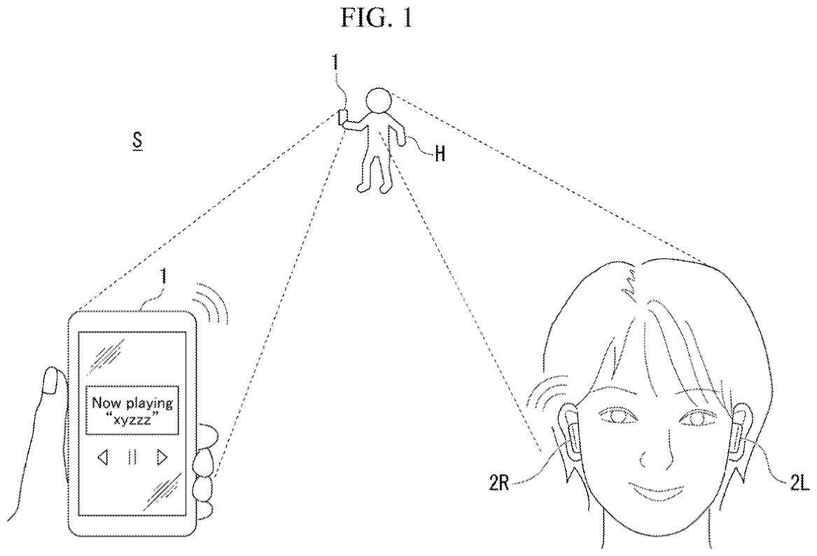

FIG. 1 shows an example of the configuration of the authentication system S in the first example embodiment. The authentication system S is provided with an information communication device 1, a right earphone 2R, and a left earphone 2L. A user H wears the right earphone 2R and the left earphone 2L in his/her ears. The user H uses the information and communication device 1. The information and communication device 1 is an electronic device equipped with a communication function. The information communication device 1 can be, for example, a smartphone, a tablet computer, a wristwatch-type portable terminal, or a personal computer (PC).

Since the functions of the right earphone 2R and left earphone 2L are common, the right earphone 2R and left earphone 2L are collectively referred to as the earphone 2 unless otherwise specified. In FIG. 1, music is being played by the information communication device 1, and the user H is listening to the music using the earphone 2. The information communication device 1 and the earphone 2 are connected to each other by wireless communication. Although not shown in the figure, the earphone 2 may be connected to the information communication device 1 by a wire. The information communication device 1 and the earphone 2 may be configured as a single device, or yet another device may be included within the authentication system S. In this specification, “sound” such as sound waves and audio shall include non-audible sounds whose frequency or sound pressure level is outside the audible range.

The information communication device 1 is communicatively connected to the earphone 2. The information communication device 1 controls the operation of the earphone 2, transmits audio data for generating sound waves emitted from the earphone 2, and receives audio data obtained from sound waves received by the earphone 2. Specifically, when the user H uses the earphone 2 to listen to music, the information communication device 1 sends compressed data of music to the earphone 2.

When the earphone 2 is connected to a portable terminal for business use at an event site, hospital, or the like, the information communication device 1 may transmit audio data of business instructions to the earphone 2. In this case, the earphone 2 may transmit the audio data of the user H's speech to the information communication device 1. The information communication device 1 or earphone 2 may be provided with a function of otoacoustic authentication using the sound waves received by the earphone 2.

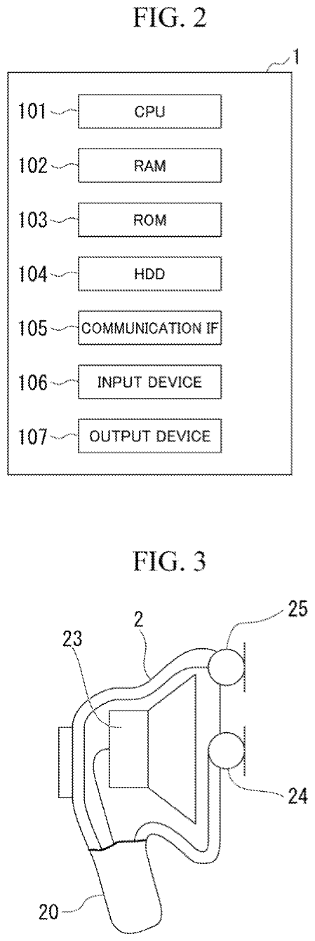

FIG. 2 is a block diagram showing the hardware configuration of the information communication device 1 in the first example embodiment. The information communication device 1 is provided with a central processing unit (CPU) 101, random access memory (RAM) 102, read-only memory (ROM) 103, and a hard disk drive (HDD) 104.

The information communication device 1 also has a communication interface (IF) 105, an input device 106, and output device 107. The CPU 101, RAM 102, ROM 103, HDD 104, communication IF 105, input device 106, and output device 107 are interconnected via buses, wiring, and driving devices not shown in FIG. 2.

The CPU 101 performs predetermined calculations in accordance with programs stored in the ROM 103, HDD 104, and the like. The CPU 101 is a processing unit that also has the function of controlling each part of the information communication device 1. The RAM 102 consists of a volatile storage medium. The RAM 102 provides a temporary memory area. The temporary memory area is necessary for the operation of the CPU 101.

The ROM 103 consists of a nonvolatile storage medium. The ROM 103 stores necessary information such as programs used in the operation of the information communication device 1. The HDD 104 consists of a nonvolatile storage medium and is a storage device that temporarily stores data sent and received to/from the earphone 2, stores programs for operating the information communication device 1, and so on. The HDD 104 may be a solid-state drive (SSD) instead of a HDD. If the information communication device 1 is a smartphone or wristwatch-type portable terminal, the information communication device 1 does not have to be equipped with the HDD 104.

The communication IF 105 is a communication interface that enables transmission and reception of data and control information, and the like, to/from other devices. The communication IF 105 is based on standards such as Bluetooth (registered trademark) and Wi-Fi (registered trademark), for example.

The input device 106 is a device used by the user H to operate the information communication device 1. The input device 106 may be a touch screen panel, for example, or a keyboard, mouse, trackball, or pen input device.

The output device 107 is display device used for display of a graphical user interface (GUI) for operation input. The output device 107 is a liquid crystal display, organic electroluminescence (EL) display, and the like. The input device 106 and the output device 107 may be integrally formed as a touch panel.

The hardware configuration shown in FIG. 2 is an example. Additional devices other than those shown in FIG. 2 may be added, or some devices may not be provided. Some of the devices shown in FIG. 2 may be replaced by other devices with similar functions. Furthermore, some functions of this example embodiment may be provided by other devices via a network. The functions of this example embodiment may be distributed and realized in multiple devices. The hardware configuration shown in FIG. 2 can be modified as needed.

FIG. 3 is a block diagram showing the hardware configuration of the earphone 2 in the first example embodiment. The earphone 2 is equipped with an earphone control device 20, a speaker 23, a microphone 24, and a proximity sensor 25.

The earphone 2 is an acoustic device that can be worn in the ear of the user H, and is a typically a device capable of wireless communication such as a wireless earphone or wireless headset. The speaker 23 functions as a sound wave generator that emits sound waves toward the ear canal of the user H when worn, and is located on the wearing side of the earphone 2. The microphone 24 is arranged on the wearing side of the earphone 2 so as to be capable of receiving sound waves that are reflected by the user H's ear canal, etc. when worn.

The proximity sensor 25 is an element that detects the degree of proximity or contact with an object. The proximity sensor 25 may be an infrared sensor. In this case, the proximity sensor 25 consists of a photodiode or similar device. The proximity sensor 25 functions as a wearing detection unit that detects infrared radiation emitted from the user H when wearing the earphone 2. The proximity sensor 25 is located on the wearing side of the earphone 2. The earphone control device 20 controls the speaker 23, microphone 24, and proximity sensor 25, and communicates with the information communication device 1.

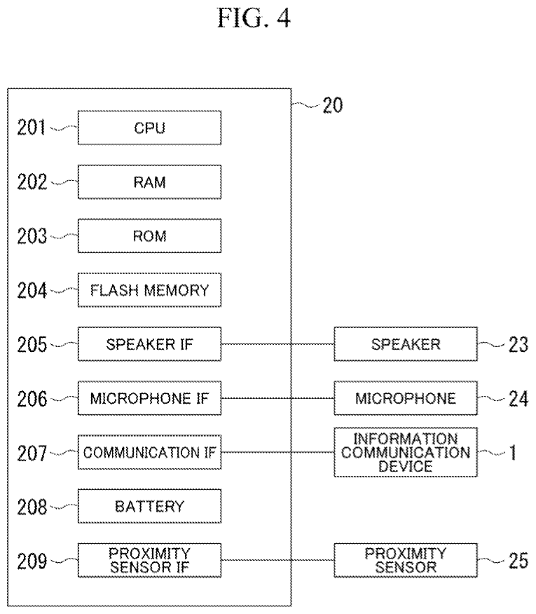

FIG. 4 is a block diagram showing the hardware configuration of the earphone control device 20 in the first example embodiment. The earphone control device 20 is provided with a CPU 201, RAM 202, ROM 203, flash memory 204, speaker IF 205, microphone IF 206, communication IF 207, battery 208, and proximity sensor IF 209. The various parts of the earphone control device 20 are interconnected via unshown buses, wiring, driving units, and the like.

The CPU 201 is an arithmetic device that performs predetermined operations according to a program stored in the ROM 203, flash memory 204, and the like. The CPU 201 controls each part of the earphone control device 20. The RAM 202 consists of a volatile storage medium. The RAM 202 provides the temporary memory area necessary for the operation of the CPU 201. The ROM 203 consists of a nonvolatile storage medium. The ROM 203 stores necessary information such as programs used in the operation of the earphone control device 20. The flash memory 204 is a storage device consisting of a nonvolatile storage medium. The flash memory 204 is used for temporary storage of data and storage of programs for operation of the earphone control device 20.

The communication IF 207 is a communication interface that enables the transmission and reception of data and control information, etc., with other devices. The communication IF 207 is based on standards such as Bluetooth (registered trademark) and Wi-Fi (registered trademark), for example. The right earphone 2R and left earphone 2L communicate with each other using the communication IF 207R and communication IF 207L, respectively, and with the information communication device 1. Only one of the right earphone 2R and left earphone 2L may be configured to communicate with the information communication device 1, while the other does not communicate with the information communication device 1.

The speaker IF 205 is an interface for driving the speaker 23. The speaker IF 205 includes a digital-to-analog conversion circuit, an amplifier, and other components. The speaker IF 205 converts audio data to analog signals and supplies them to the speaker 23. This causes the speaker 23 to emit sound waves based on the audio data.

The microphone IF 206 is an interface for acquiring signals from the microphone 24. The microphone IF 206 includes an analog-to-digital conversion circuit, an amplifier, and other components. The microphone IF 206 converts analog signals generated by sound waves received by the microphone 24 into digital signals. This allows the earphone control device 20 to acquire audio data based on the received sound waves.

The battery 208 provides the power necessary to operate the earphone 2. The battery 208 is, for example, a rechargeable battery. The battery 208 is built into the earphone 2, allowing the earphone 2 to operate wirelessly without a wired connection to an external power source.

The proximity sensor IF 209 is an interface for acquiring signals from the proximity sensor 25. The proximity sensor IF 209 includes an analog-to-digital conversion circuit, an amplifier, and the like. For example, if the proximity sensor 25 is an infrared sensor, the proximity sensor IF 209 converts the analog signal generated by the infrared light received by the proximity sensor 25 into a digital signal. The earphone control device 20 thereby acquires the detection data of the user H based on the received infrared light.

The hardware configuration shown in FIG. 4 is an example, and devices other than these may be added, or some of the hardware shown in FIG. 4 may not be provided. Some of the devices may be replaced by other devices with similar functions. For example, the earphone 2 may be further equipped with an input device, such as a button, with such an input device being capable of accepting operations by the user H. The earphone 2 may be further equipped with a display, indicator light, or other display device to provide information to the user H. Thus, the hardware configuration shown in FIG. 4 can be modified as needed.

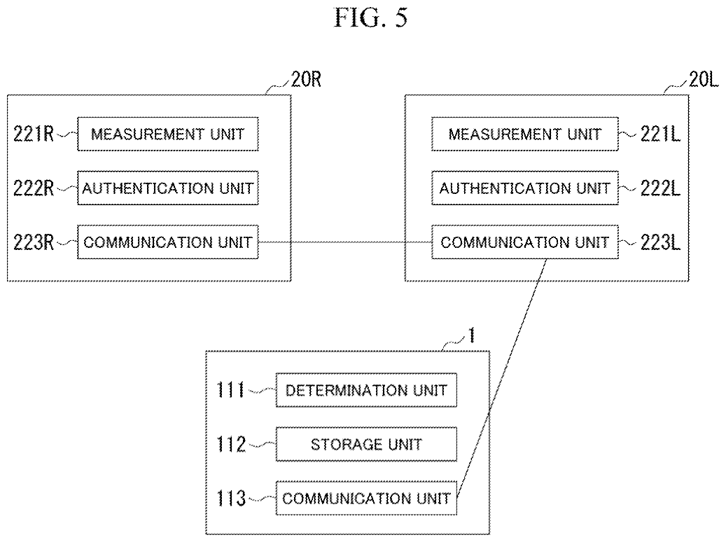

FIG. 5 is a functional block diagram of the information communication device 1, earphone control device 20R and earphone control device 20L in the first example embodiment. In this example embodiment, components with the suffix “R” represent components of the right earphone. Components with the suffix “L” represent components of the left earphone 2L. If the suffix “R” or “L” is not appended, it shall indicate not being limited to the right earphone 2R and left earphone 2L.

The right earphone 2R and left earphone 2L are connected to each other via the communication unit 223R and the communication unit 223L. The information communication device 1 and the left earphone 2L are connected to each other via the communication unit 113 and the communication unit 223L. In FIG. 5, the line connecting the communication unit 223R and the communication unit 223L and the line connecting the communication unit 223L and the communication unit 113 indicate that there is a physical connection relationship between the right earphone 2R and the left earphone 2L and between the left earphone 2L and the information communication device 1. The connection between them can be achieved not only wirelessly but also through wired means.

### (Information and Communication Device 1)

The information communication device 1 is equipped with a determination unit 111, a storage unit 112, and a communication unit 113. The determination unit 111 determines whether or not the right earphone 2R is connected to the right ear of the user H based on information indicating the wearing state between the user H's right ear and the right earphone 2R (right earphone wearing state information). The determination unit 111 determines whether or not the left earphone 2L is connected to the left ear of the user H based on information indicating the wearing state between the left ear of the user H and the right earphone 2L (left earphone wearing state information). The information communication device 1 may be referred to as an authentication management device.

The storage unit 112 is a storage device that stores various control information and data. The storage unit 112 stores information indicating whether the authentication of the user H by the authentication unit 222R was successful or not and information indicating whether the authentication of the user H by the authentication unit 222L was successful or not. The storage unit 112 may store the right earphone wearing state information and the left earphone wearing state information. The storage unit 112 may store the determination result concerning whether the right earphone 2R is worn on the right ear of the user H (right earphone wearing state determination result) and the determination result concerning whether the left earphone 2L is worn on the left ear of the user H (left earphone wearing state determination result).

The storage unit 112 is at least one of the RAM 102, ROM 103, and HDD 104. The storage unit 112 may be an external HDD, flash memory, and the like. The CPU 101 loads a program stored in the ROM 103, HDD 104, and the like into the RAM 102 for execution.

The CPU 101 controls at least one of the RAM 102, ROM 103, and HDD 104 based on the program to realize the functions of the storage unit 112. The specific processes performed in each of these units are described below.

The communication IF 105 communicates with the earphone 2L and other devices. The communication unit 113 is connected to the communication unit 222L. The communication IF 105 may obtain the authentication result by the authentication unit 222R and the authentication result by the authentication unit 222L from the left earphone 2L via the communication IF 207L. As a result, the communication IF 105 realizes the function of the communication unit 113. The communication unit 113 may communicate directly with the right earphone 2R via the communication IF 207R.

The specific processes performed in the determination unit 111, storage unit 112, and communication unit 113 shall be described below. These functions in the information communication device 1 may be realized by the earphone control device 20, or by the information communication device 1 and the earphone control device 20 working together.

### (Earphone Control Device 20)

The earphone control device 20 is equipped with a measurement unit 221, an authentication unit 222, and a communication unit 223. The CPU 201 loads and executes programs stored in the ROM 203, flash memory 204, and the like into the RAM 202 for execution. This allows the CPU 201 to perform the functions of the measurement unit 221 and the authentication unit 222. The processes of the measurement unit 221 and the authentication unit 222 are described in detail below.

The communication IF 207 sends and receives control information and data to and from the information communication device 1. The right earphone 2R and the left earphone 2L are used as a pair. The communication IF 207R and the communication IF 207L communicate with each other. As a result, the communication IF 207 realizes the function of the communication unit 223. In FIG. 5, the communication unit 223R of the right earphone 2R is not connected to the communication unit 113 of the information communication device 1, but may be configured for connection.

The CPU 201 loads the program stored in the ROM 203, flash memory 204, etc. into the RAM 202 for execution, and based on the authentication result by the authentication unit 222R and the authentication result by the authentication unit 222L, the CPU 201 generates information indicating whether the authentication of the user's right ear by authentication unit 222R was successful or not (right ear authentication result) and information indicating whether the authentication of the user's left ear by the authentication unit 222L was successful of not (left ear authentication result).

The communication IF 207R outputs the right ear authentication result to the left earphone 2L. The communication IF 207R may output the right ear authentication result to the information communication device 1. The communication IF 207L outputs the left ear authentication result and the right ear authentication result to the information communication device 1. The earphone 2R and the left earphone 2L may be referred to as the authentication management device.

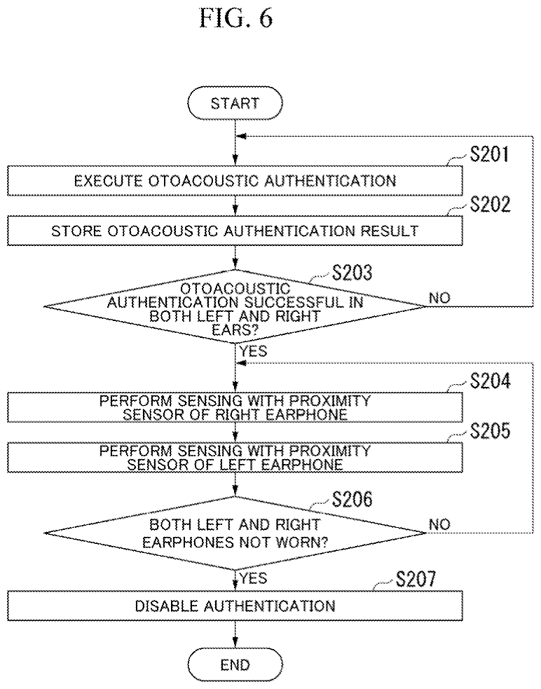

FIG. 6 is a flowchart showing the process flow of the authentication system S in the first example embodiment.

In Step S201, otoacoustic authentication is performed on the right ear of the user H by the authentication unit 222R of the right earphone 2R. The authentication unit 222R performs authentication of the user H using the CPU 201R, the RAM 202R, the ROM 203R, the flash memory 204R, the speaker IF 205 and the speaker 23. In other words, the authentication unit 222 determines whether or not the user H is a registrant by means of otoacoustic authentication. Similarly, for the left earphone 2L, otoacoustic authentication is performed by the authentication unit 222L.

Otoacoustic authentication is a biometric authentication that collates the acoustic characteristics of the user H's ear canal. By emitting inspection sound waves into the ear canal of the user H by the speaker 23 and receiving the sound waves reflected by user H's ear canal by the microphone 24, the earphone 2 can acquire the acoustic characteristics of the user H's ear canal.

The authentication unit 222 can determine whether the user H is a registrant or not by collating the feature quantities extracted from the acquired acoustic characteristics of the ear canal with the feature quantities extracted from the acoustic characteristics of the registrant's ear canal. A registrant is a person who is an authorized user of the earphone 2 and for whom the acoustic characteristics or feature quantities of the ear canal have been registered. This authentication allows the earphone 2 functions to be restricted for unauthorized persons and prevents unauthorized persons from using the earphone 2.

In the present example embodiment, the acoustic characteristics of the registrant's ear canal are assumed to be stored in advance in the storage unit 112, however, the acoustic characteristics of the registrant's ear canal may be acquired from other devices such as the information communication device 1 during authentication.

The acoustic characteristics acquired in otoacoustic authentication are typically those resulting from resonance in the ear canal. Acoustic characteristics acquired in otoacoustic authentication can also include acoustic characteristics resulting from reverberation in tissues surrounding the ear canal, such as the skull. The examination sound waves do not have to be emitted directly into the ear canal. The examination sound waves may be emitted to a portion of the user H's head by a bone-conduction speaker.

The communication unit 223R outputs information indicating whether or not the user's right ear was successfully authenticated by the authentication unit 222R (right ear authentication result) to the left earphone 2L using the communication IF 207R. The communication unit 223L acquires the right ear authentication result and outputs it together with the left ear authentication result to the information communication device 1 using the communication IF 207L. The communication unit 223L advances the processing to Step S205.

In Step S202, the communication unit 113 acquires the right ear authentication result and the left ear authentication result using the communication IF 105. The storage unit 112 stores the acquired right-ear and left-ear authentication results. The storage unit 112 advances the processing to Step S203.

In Step S203, the determination unit 111 reads the right ear authentication result and the left ear authentication result, and checks whether both the right ear authentication result and the left ear authentication result indicate that the authentication was successful. If both the right and left ear authentication results indicate that the authentication was successful, the determination unit 111 creates information instructing the confirmation of the wearing state (wearing state confirmation instruction information). The communication unit 113 outputs the wearing state confirmation instruction information to the left earphone 2L using the communication IF 105. The communication unit 113 advances the processing to Step S204.

If either the right ear authentication result or left ear authentication result indicates that authentication has failed, the determination unit 111 advances the processing to Step S201.

In Step S204, the communication unit 223L outputs the wearing state confirmation instruction information to the right earphone 2R. The communication unit 223R acquires the wearing state confirmation instruction information. The measurement unit 221R measures the intensity of infrared radiation by a proximity sensor IF 209R and a proximity sensor 25R (infrared sensor). The communication unit 223R outputs the right earphone wearing state information to the earphone control device 20L by the communication IF 207R. The communication unit 223R advances the processing to Step S205.

In Step S205, the measurement unit 221L measures the intensity of infrared radiation by a proximity sensor IF 209L and a proximity sensor 25L (infrared sensor) and outputs it to the communication unit 223L as the left earphone wearing state information. The communication unit 223L acquires the right earphone wearing state information and left earphone wearing state information by the communication IF 207L. The communication unit 223L outputs the right earphone wearing state information and left earphone wearing state information to the information communication device 1 by the communication IF 207L. The communication unit 223L advances the processing to Step S206.

In Step S206, the communication unit 113 acquires the right earphone wearing state information and the left earphone wearing state information using the communication IF 105. The determination unit 111 uses the CPU 101 and at least one of the RAM 102R, ROM 103R, and HDD 104, etc. to determine whether both the earphone 2R and left earphone 2L are not worn by the user based on the right earphone wearing state information and left earphone wearing state information.

When the user H is wearing the earphone 2, the infrared radiation emitted from the user H is incident on the proximity sensor 25, so the intensity of the infrared radiation received by the proximity sensor 25 increases. Therefore, the determination unit 111 can determine whether or not the right earphone 2R is worn based on a digital signal indicating the intensity of the infrared radiation received by the proximity sensor 25R (right earphone wearing state information). The determination unit 111 can determine whether or not the left earphone 2L is worn based on a digital signal indicating the intensity of the infrared radiation received by the proximity sensor 25L (left earphone wearing state information).

For example, the determination criteria by the determination unit 111 may be determining that the user H is wearing the earphone 2 when the intensity of infrared radiation (right earphone wearing state information or left earphone wearing state information) is equal to or greater than a threshold value. Alternatively, the criteria may involve calculating a wear score based on the intensity of the infrared radiation or change thereof, and determining that the user H is wearing the earphone 2 when the wear score equal to or greater than above a threshold value.

The determination unit 111, upon determining that both the earphone 2R and left earphone 2L are not worn by the user, acquires a wearing determination result indicating whether the earphones are worn in the user's ears or not. The communication unit 113 outputs the wearing determination result and information instructing the invalidation of the authentication status (authentication cancellation instruction information) to the left earphone 2L using the communication IF 105. The communication unit 223L acquires the wearing state determination result and the de-authentication instruction information using the communication IF 207L and outputs them to the right earphone 2R. The communication unit 223R uses the communication IF 207R to acquire the de-authentication instruction information. The communication unit 223L and the communication unit 223R advance the processing to Step S207.

In Step S206, if the determination unit 111 determines that only one of the earphone 2R and the left earphone 2L is not worn by the user, the processing proceeds to Step S204.

In Step S207, the authentication unit 222R and the authentication unit 222L disable the authentication of the user H in the right earphone 2R and left earphone 2L, respectively. The communication unit 113 ends the processing.

As described above, the authentication management device according to the first example embodiment of the present disclosure is provided with an authentication result acquisition means (communication unit 113) that acquires an authentication result of authenticating a user by otoacoustic authentication in an earphone (for example, the right earphone 2R and the left earphone 2L); a storage means (for example, the storage unit 112) that stores the authentication result; a determination result acquisition means (for example, the determination unit 111) that, after the authentication result is acquired, acquires a wearing determination result indicating whether the earphone is worn in an ear of the user on the basis of a detection result of a proximity sensor; and a control means (for example, the storage unit 112) that updates the authentication result stored in the storage means when the wearing determination result indicates that the earphone is not worn in the ear.

The authentication means is an authentication means in otoacoustic authentication that sends out a test sound in the direction of the ear canal of one or the other ear, and authenticates the user on the basis of the sound reflected in response to the test sound.

This allows fast control of the user authentication state based on the wearing state of the earphones.

The authentication unit 222R may directly output the right earphone wearing state information and the right ear authentication result to the information communication device 1. The communication IF 105 may directly output the wearing state confirmation instruction information, authentication execution instruction information, and authentication cancellation instruction information to the right earphone 2R.

The communication unit 113 of the information communication device 1 (e.g., smartphone) may also acquire from another device a request seeking authentication of the user H (authentication request) in the other device. In this case, the communication unit 113 may read the right ear authentication result and left ear authentication result from the storage unit 112 and output them to the other device. If both the right ear authentication result and left ear authentication result indicate that the authentication was successful, or if either the right ear authentication result or left ear authentication result indicate that the authentication was successful, the other device may authenticate the user.

Here, the other device may be, for example, building access control equipment or an authentication device installed at airport baggage checkpoint gates, immigration gates, and the like. The authentication request from the other device may be obtained directly by the earphone 2 by means of the communication unit 223, without going through the information communication device 1.

As a result, if the user H is authenticated by the information communication device 1, other devices can authenticate the user H without further authentication processing, thus enabling secure and smooth user access control or authentication by other devices.

In the above, when the communication unit 113 acquires a required security level in addition to authentication requests from other devices, the storage unit 112 may store the authentication history of the user H for a predetermined period in the information communication device 1 described in steps S201 to S207. The authentication history indicates the history of successful authentication of the user H and the history of de-authentication of the user H in the information communication device 1. If the required security level is high and the authentication history indicates that user H has been successfully authenticated less than a predetermined number of times within a predetermined period of time, the communication unit 113 may output a request to the left earphone 2L to perform otoacoustic authentication (otoacoustic authentication request).

The communication unit 223L receives the otoacoustic authentication request. The communication unit 223L may output the otoacoustic authentication request to right earphone 2R, and the communication unit 223R may receive the otoacoustic authentication request. Steps S201 through S203 are then executed. The communication unit 113 outputs the right ear authentication result and left ear authentication result to the other device before proceeding to step S204 or Step S201. If the authentication is indicated as successful in both the right ear authentication result and left ear authentication result, or if the authentication is indicated as successful in either the right ear authentication result or left ear authentication result, the other device may authenticate user H.

In the above, if the required security level is low and the authentication history indicates that user H has been successfully authenticated a predetermined number of times within a predetermined period or that the percentage of times the user H has been successfully authenticated is equal to or greater than a predetermined value, the communication unit 113 may perform the output to the other device including information indicating the success of authentication in both the right ear authentication result and left ear authentication result. The other device may then authenticate user H.

This allows other devices to authenticate the user H without further authentication based on the authentication history of the user H in the information communication device 1 and the required security level in the other devices, thus realizing secure and smooth user access control or authentication by other devices.

### Second Example Embodiment

The authentication system S according to the second example embodiment of this disclosure is described with reference to the drawings. In the authentication system S according to the second example embodiment, the respective configurations of the information communication device 1 and the earphone 2 are the same as in the first example embodiment.

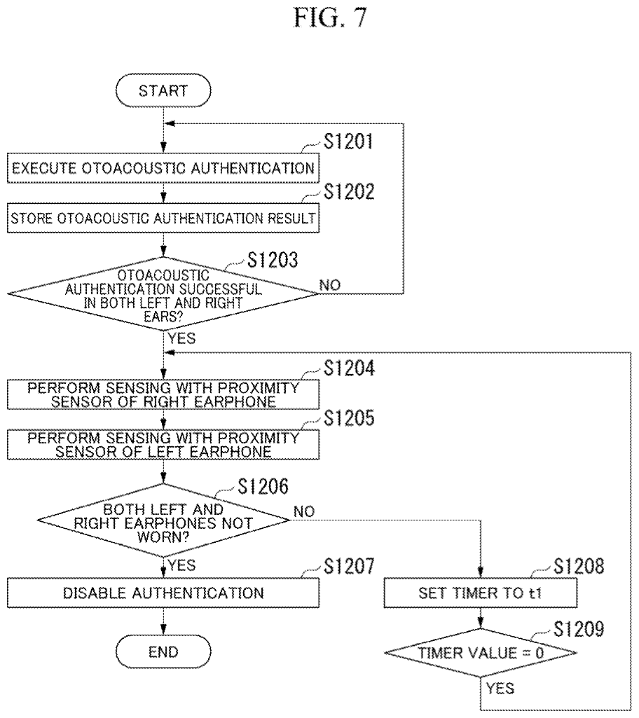

FIG. 7 is a flowchart showing the process flow of the authentication system S in the second example embodiment. The respective processes from Step S1201 to Step S1207 in FIG. 7 are in principle the same as the respective processes from Step S201 to Step S207 in FIG. 6, but the processing when the determination result is “No” in Step S1206 is different.

If, in Step S1206, the determination unit 111 determines that only one of the earphone 2R and the left earphone 2L is not worn by the user, the processing proceeds to step S1208.

In Step S1208, the determination unit 111 sets the value of an internal timer 1 to t1. t1 can be set arbitrarily according to the requirement condition and can be in milliseconds, seconds or minutes. The determination unit 111 starts decrementing the timer value and proceeds to Step S1209.

When the timer value reaches 0 in Step S1209, the determination unit 111 advances the processing to Step S1204. After Step S1207, the storage unit 112 ends the processing.

As described above, the authentication management device according to the second example embodiment of the present disclosure periodically performs at each first predetermined period a determination as to whether or not the earphone is worn in the ear, in the determination result acquisition means.

This eliminates the need to constantly check the wearing state after the authentication process, thereby reducing processing resources. In addition, battery consumption can be reduced.

### Third Example Embodiment

The authentication system S according to the third example embodiment of the present disclosure is described with reference to the drawings. In the third example embodiment of the authentication system S, the configuration of the information communication device 1 and the earphone 2 is the same as in the first and second example embodiments.

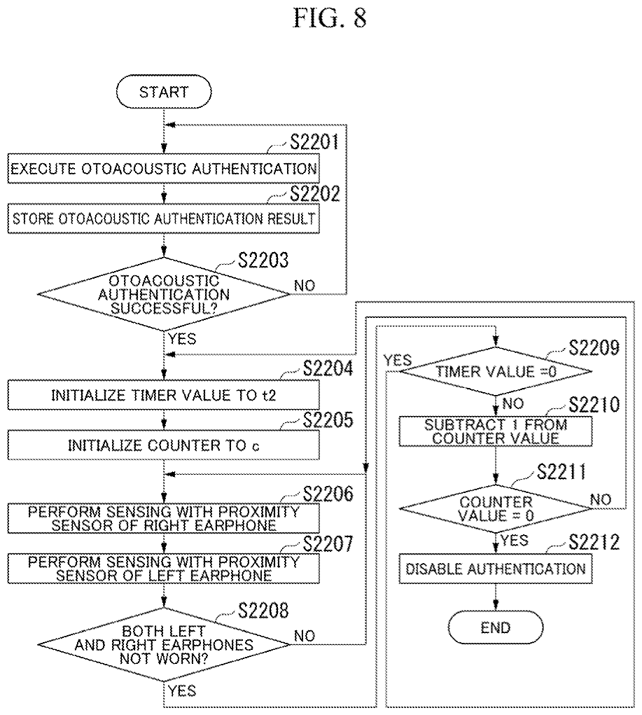

FIG. 8 is a flowchart showing the process flow of the authentication system S in the third example embodiment. In FIG. 8, each process from Step S2201 to Step S2203 is the same as each process from Step S201 to Step S203. If the determination result of Step S2203 is “Yes”, the determination unit 111 proceeds to Step S2204.

In Step S2204, the determination unit 111 initializes the value of timer 2 held internally to t2 and starts subtracting from the timer value. The determination unit 111 proceeds to Step S2205.

In Step S2205, the determination unit 111 initializes the value of the counter held internally to c. The determination unit 111 proceeds to Step S2206.

Each process from Step S2206 to Step S2208 is similar in principle to each process from Step S204 to Step S206, but the process when the determination result is “Yes” in Step S2208 is different from Step S206.

In Step S2208, if the determination unit 111 determines that both earphone 2R and left earphone 2L are not worn by the user, the processing proceeds to Step S2209.

In Step S2209, the determination unit 111 determines whether the timer value of the timer 2 is 0 or not. If the timer value is 0, the determination unit 111 proceeds to Step S2204. If the timer value is not 0, the determination unit 111 proceeds to Step S2210.

In Step S2210, the determination unit 111 subtracts 1 from the counter value and proceeds to Step S2211.

In Step S2211, if the counter value is 0, the determination unit 111 proceeds to Step S2212. If the counter value is not 0, the determination unit 111 proceeds to Step S2204.

The processing in Step S2212 is similar to the processing in Step S207. After Step S2212, the determination unit 111 ends the processing.

Here, in Step S2211, if the counter value is 0, the determination unit 111 proceeds to Step S2212. In this case, the counter has become zero before the timer value expires. In this case, that is, the number of times that both earphone 2R and left earphone 2L were determined to be not worn by the user before the predetermined time elapsed exceeded the predetermined number of times (i.e., the upper limit number, which is the threshold value).

The wearing state confirmation process for the right earphone 2R and left earphone 2L in Step S2206 and Step S2207 is performed after the authentication process in both ears is successful. In this case, depending on the operating environment of the earphones, even if the earphones are being worn, the determination unit 111 may mistakenly determine that they are not being worn due to instantaneous fluctuations in the operating environment of the earphones.

Therefore, with the introduction of the timer 2 and a counter, the determination unit 111 invalidates the authentication status of both ears only when the non-wearing state is detected in both the left and right ears for a predetermined number (threshold number) within a predetermined period.

As described above, in the authentication management device of the first example embodiment of the present disclosure, when the second determination means (e.g., the determination unit 111) determines that the earphone (e.g., right earphone 2R or left earphone 2L) is not worn in the ear more than a predetermined number of times during a second predetermined period, the control means (e.g., the determination unit 111) updates and stores the authentication result in the storage means (e.g., the storage unit 112).

As a result, the determination unit invalidates the authentication status of both ears only when the non-wearing state has been detected for a predetermined number (threshold number) of times within a predetermined period of time in both the left and right ears, thus preventing undesirable cancellation of the authentication status based on misdetermination of the wearing state and improving authentication accuracy.

### Fourth Example Embodiment

The authentication system S according to the fourth example embodiment of the present disclosure is described with reference to the drawings. In the fourth example embodiment of the authentication system S, the hardware configuration of the information communication device 1 and the earphone 2 is the same as in the first example embodiment.

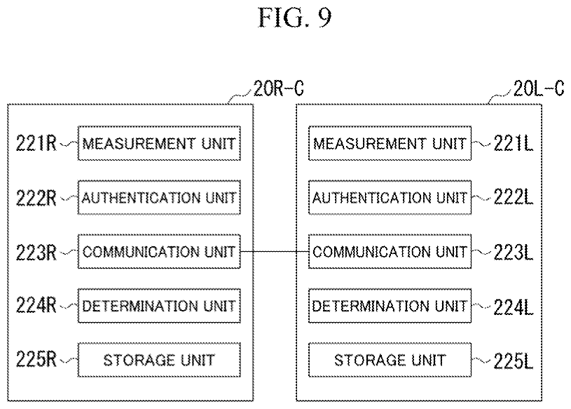

FIG. 9 is a functional block diagram of the earphone 2 in the fourth example embodiment. An earphone control device 20R-C is further equipped with a determination unit 224R and a storage unit 225R. An earphone control device 20L-C is further provided with a determination unit 224L and a storage unit 225L. The specific processes performed in the determination unit 224 and the storage unit 225 are described below.

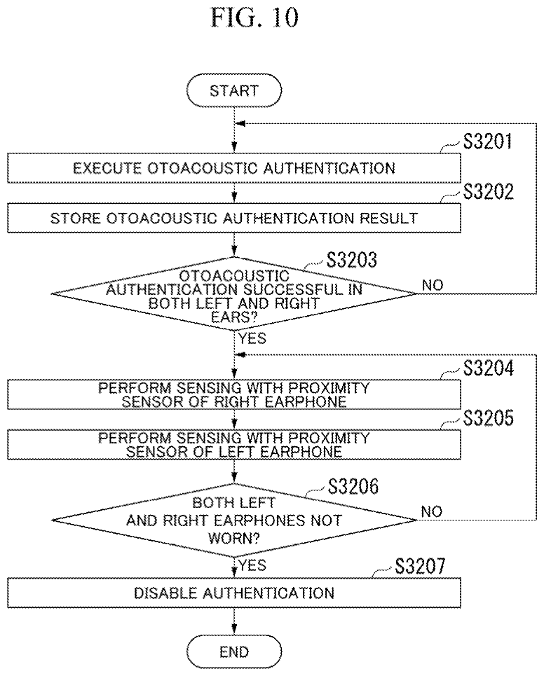

FIG. 10 is a flowchart showing the process flow of the authentication system S in the fourth example embodiment.

In Step S3201, otoacoustic authentication is performed on the right ear of user H by the authentication unit 222R of the right earphone 2R. Similarly, in the left earphone 2L, otoacoustic authentication is performed by the authentication unit 222L. The communication unit 223R outputs information indicating whether or not the user's right ear was successfully authenticated by the authentication unit 222R (right ear authentication result) to the left earphone 2L using the communication IF 207R. The communication unit 223L obtains the right ear authentication result.

In Step S3202, the storage unit 225L stores the right ear authentication result and left ear authentication result. The storage unit 225L advances the processing to Step S3203.

In Step S3203, the determination unit 224L reads the right ear authentication result and the left ear authentication result, and checks whether both the right ear authentication result and the left ear authentication result indicate that the authentication was successful. If both the right and left ear authentication results indicate that the authentication was successful, the determination unit 224L generates information instructing the confirmation of the wearing state (wearing state confirmation instruction information). The communication unit 223L outputs the wearing state confirmation instruction information to the right earphone 2R using the communication IF 207L. The communication unit 223R uses the communication IF 207R to acquire the wearing state confirmation instruction information. The communication unit 223L and the communication unit 223R advance the processing to Step S3204.

If either the right ear authentication result or left ear authentication result indicates that authentication has failed, the determination unit 224L advances the processing to Step S3201.

In Step S3204, the measurement unit 221R measures the intensity of infrared radiation by the proximity sensor IF 209R and the proximity sensor 25R (infrared sensor). The communication unit 223R outputs the right earphone wearing state information to the earphone control device 20L by the communication IF 207R. The communication unit 223R advances the processing to Step S3205.

In Step S3205, the measurement unit 221L measures the intensity of the infrared radiation by the proximity sensor IF 209L and the proximity sensor 25L (infrared sensor) and retains it as the left earphone wearing state information. The storage unit 225 may store the left earphone wearing state information. The communication unit 223L acquires the right earphone wearing state information by the communication IF 207L. The communication unit 223L advances the processing to Step S206.

In Step S3206, the determination unit 224L uses the CPU 201L and at least one of the RAM 202L, ROM 203L, and flash memory 204L, etc., to determine whether both the earphone 2R and left earphone 2L are not worn by the user based on the right earphone wearing state information and left earphone wearing state information.

If the determination unit 224L determines that both the earphone 2R and the left earphone 2L are not worn by the user, the communication unit 223L uses the communication IF 207L to output information instructing invalidation of the authentication state (authentication cancellation instruction information) to the right earphone 2R. The communication unit 223R uses the communication IF 207R to acquire the de-authentication instruction information. The communication unit 223L and the communication unit 223R advance the processing to Step S207.

If the determination unit 224L determines that only one of the earphone 2R and the left earphone 2L is not worn by the user, the processing proceeds to Step S3204.

In Step S3207, the authentication unit 222R and the authentication unit 222L disable the authentication of the user H in the right earphone 2R and left earphone 2L, respectively. The authentication unit 222R and the authentication unit 222L end the process.

As described above, unlike the first example embodiment, the authentication management device according to the fourth example embodiment of the present disclosure controls otoacoustic authentication based on the wearing state of the right earphone 2R and left earphone 2L, using only the right earphone 2R and left earphone 2L without using the information communication device 1.

This allows simple and fast control of the user authentication state based on the wearing state of the earphones.

### Fifth Example Embodiment

The authentication system S according to the fifth example embodiment of the present disclosure is described with reference to the drawings.

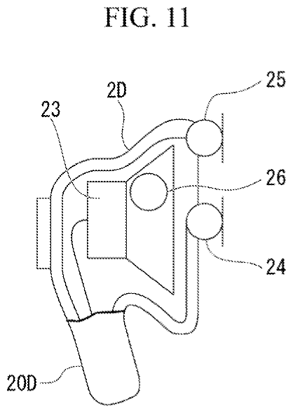

FIG. 11 is a block diagram showing the hardware configuration of an earphone 2D in the fifth example embodiment. The earphone 2D is provided with a motion sensor 26 inside in addition to the earphone 2 of the first through third example embodiments. The motion sensor 26 is provided with an accelerometer and a gyro sensor. The motion sensor 26 senses sensor information indicating the user's motion, such as up-and-down movement of the body during the user H's moving actions and the impact when landing on the ground.

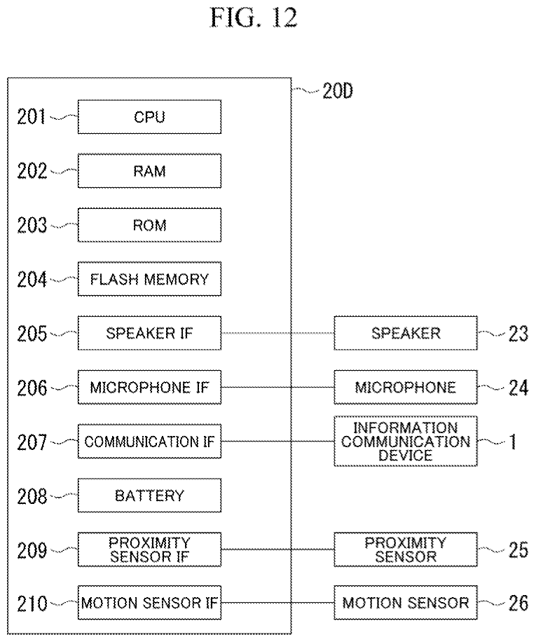

FIG. 12 is a block diagram showing the hardware configuration of the earphone control device 20D in the fifth example embodiment. The earphone control device 20D is provided with a motion sensor IF 210 in addition to the earphone control device 20 of the first through fourth example embodiments. The motion sensor IF 210 is an interface that controls the sensing operation of the motion sensor 26.

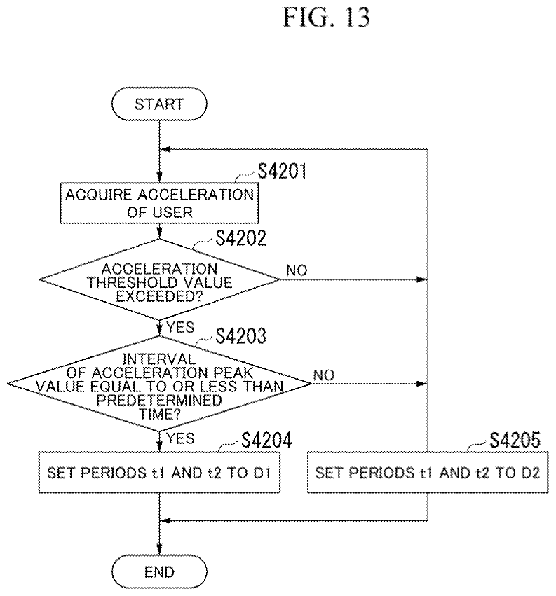

FIG. 13 is a flowchart for setting the monitoring period in the fifth example embodiment. Monitors and monitoring periods are described below. In the second and third example embodiments, timers 1 and 2 were used by the determination unit 111 to determine the wearing state of the earphone. In the fifth example embodiment, the timer values set for timers 1 and 2 are based on the estimated motion of the user H.

In Step S4201, the measurement unit 221L acquires the acceleration of the user H using a motion sensor IF 210L and a motion sensor 26L. The communication unit 223L outputs the measurement value of the acceleration to the information communication device 1 using the communication IF 207L. The communication unit 113 obtains the measurement value of the acceleration using the communication IF 207. The communication unit 113 may also acquire the acceleration acquired by the earphone control device 20R via the earphone control device 20L. The communication unit 223L and the communication unit 113 advance the processing to Step S4202.

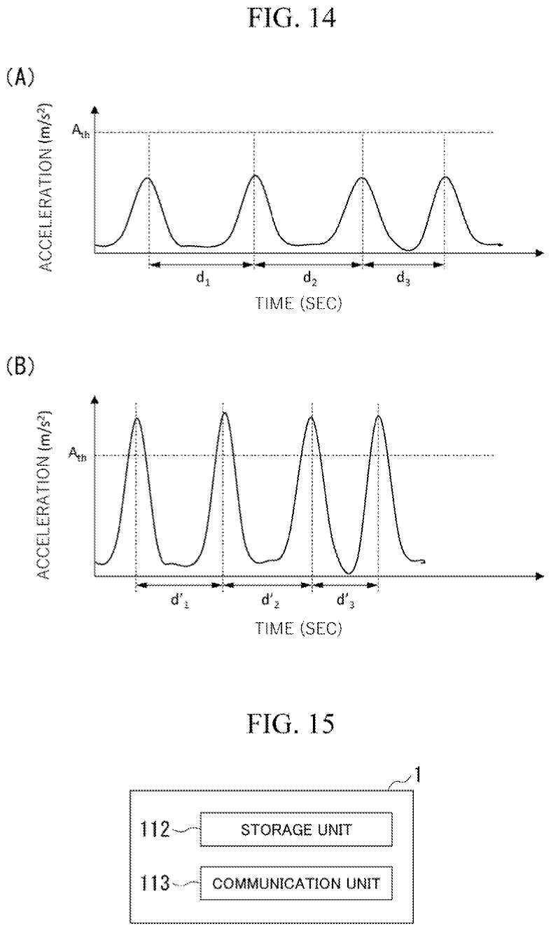

FIG. 14 is a graph showing the temporal transition of the sensor information in the fifth example embodiment. FIG. 14(A) shows the temporal transition of acceleration (m/s²) when the user H is walking. FIG. 14(B) shows the temporal transition of acceleration (m/s²) when the user H is running. Assume that the accelerations shown in FIGS. 14(A) and 14(B) were acquired by the motion sensor 26L. As can be seen from FIG. 14, when walking, the user's acceleration does not exceed the threshold value Aₜₕ, but when running, the user's acceleration exceeds the threshold value Ain.

When the user is walking, the intervals d₁, d₂ and d₃ of the peak acceleration values are longer than the intervals d_{′1}, d_{′2} and d_{′3} of the peak acceleration values when the user is running. Therefore, the intensity of exercise of the user H can be estimated from the magnitude of acceleration or the interval between peak values of acceleration.

In Step S4202, the determination unit 111 determines whether the acceleration acquired from the left earphone 2L exceeds the predetermined threshold value Aₜₕ. If the acceleration acquired from the left earphone 2L exceeds the predetermined threshold value Aₜₕ, the determination unit 111 determines that the user H is performing high-intensity exercise such as running, and proceeds to Step S4203. If the acceleration acquired from the left earphone 2L does not exceed the predetermined threshold value Aₜₕ, the determination unit 111 determines that user H is performing low-intensity exercise such as walking, and proceeds to Step S4205.

When determining the magnitude of acceleration, the determination unit 111 may advance the processing to Step S4203 if the number of times the threshold value Aₜₕ is exceeded within the predetermined period is greater than a predetermined number.

In Step S4203, the determination unit 111 obtains the intervals of peak values of the acceleration acquired from the left earphone 2L and finds the average value of the intervals of peak values. If the calculated average value exceeds the predetermined threshold value Dₜₕ, the determination unit 111 determines that the user H is performing high-intensity exercise such as running, and proceeds to Step S4204. If the average value acquired does not exceed the predetermined threshold value Dₜₕ, the determination unit 111 determines that user H is performing low-intensity exercise such as walking, and proceeds to Step S4205.

In Step S4204, the determination unit 111 sets t1 and t2, which are the respective values of timer 1 and timer 2, to D1. The determination unit 111 ends the process.

In Step S4205, the determination unit 111 sets the timer values t1 and t2 to D2. Note that D1<D2. The determination unit 111 ends the process.

Only either Step S4202 or Step S4203 may be performed to determine whether to perform Step S4204 or Step S4205.

Subsequently the aforementioned timer values t1 and t2 are set, and the authentication operations according to the second and third example embodiments are performed based on the flowcharts shown in FIGS. 7 and 8.

As explained above, the authentication management device according to the fifth example embodiment of the present disclosure is further provided with an estimation means (determination unit 111) that estimates the user's motion, and the determination result acquisition means sets the first predetermined period on the basis of the estimated motion of the user.

The authentication management device according to the fifth example embodiment of the present disclosure is further provided with an estimation means (determination unit 111) that estimates the user's motion, and the determination result acquisition means sets the second predetermined period on the basis of the estimated motion of the user.

When the user H's exercise intensity is high, the earphone 2 is likely to fall out, so determining the wearing state in a short period is considered to be effective in maintaining the authentication status. This allows simple and fast control of the user authentication state based on the wearing state of the earphones, depending on the frequency according to the intensity of the user H's exercise.

In addition, if the user H's exercise intensity is low, the earphones are unlikely to fall out, so determining the wearing state in a short period would be rather wasteful of processing resources and battery consumption. Thereby, it is possible to easily and quickly control the user authentication state based on the wearing state of the earphones, depending on the frequency according to the intensity of the user H's exercise, and to reduce battery consumption.

Although preferred example embodiments of the present disclosure have been described in detail with reference to the drawings, specific configurations are not limited to these example embodiments, and designs and the like that do not depart from the gist of this disclosure are also included.

In the example embodiment described above, the earphone 2 is shown as an example of a wearable device, but such a device is not limited to one worn in the ear as long as it can acquire the acoustic information necessary for processing. For example, a wearable device may be a bone-conducting acoustic device.

In the earphone 2 wearing determination by the proximity sensor 25, the proximity sensor 25 may be equipped with a light source such as an LED and a photodiode. The proximity sensor 25 may emit light from a light source and detect the reflected wave of that light with a photodiode. The determination unit 224 may make a determination of wearing of the earphone 2 based on the presence or absence of the reflected wave of that light or the time until the reflected wave is received.

In the example embodiment described above, an infrared sensor is exemplified as a means of determining wearing by the proximity sensor 25, but it is not limited thereto as long as wearing determination is possible. For example, the proximity sensor 25 may emit sound waves into the ear canal of the user H, and the determination unit 224 may acquire the acoustic characteristics of the echo sound, such as the intensity of the echo sound and echo duration, and thereby make a wearing determination based on the acoustic characteristics of the echo sound. In this case, speaker 23 and microphone 24 function as devices not only for otoacoustic authentication, but also for determining the wearing of the device. Therefore, the device configuration can be simplified.

In the first example embodiment described above, it is assumed that the feature quantities are sent from the earphone 2 to the information communication device 1, but it is also possible to send data on the acoustic characteristics of the ear canal. In this case, the process of feature quantity extraction may be performed by the information communication device 1. In this example, the amount of communication increases, but the amount of computation within the earphone 2 can be reduced.

A processing method that records a program causing the operation of the configuration of the aforementioned example embodiments to realize the functions of the example embodiments in a storage medium, reads the program recorded in the storage medium as code and executes the code in a computer is also included within the scope of each example embodiment. In other words, a computer-readable storage medium is also included in the scope of each example embodiment. In addition, not only the storage medium in which the above-mentioned program is recorded, but also the program itself is included in each example embodiment. One or more components included in the example embodiments described above may be an ASIC (application specific integrated circuit), FPGA (field programmable gate array), or other circuit configured to realize the functions of each constituent element.

For example, a floppy (registered trademark) disk, hard disk, optical disk, optical magnetic disk, CD (Compact Disk)-ROM, magnetic tape, non-volatile memory card, and ROM can be used as the storage medium. The programs recorded on the storage media are not limited to those that execute processing by themselves, but also include those that operate on an OS (Operating System) and execute processing in collaboration with other software and expansion board functions.

The services realized by the functions of each of the above forms can also be provided to users in the form of SaaS (Software as a Service).

The above example embodiments are merely examples of example embodiments for implementing this disclosure, and the technical scope of this disclosure should not be interpreted as being limited thereto. In other words, this disclosure can be implemented in various forms without deviating from its technical concept or its main features.

FIG. 15 is a drawing showing the minimum configuration of the authentication management device 1 in the present disclosure.

The authentication system S according to the present example embodiment should at least be provided with the storage unit 112 and the communication unit 113 (acquisition unit) 226.

The communication unit 113 (acquisition unit) acquires the results of user authentication by otoacoustic authentication in the earphone.

The storage unit 112 stores the authentication result.

After acquisition of the authentication result, the communication unit 113 (acquisition unit) acquires the wearing determination result, which indicates whether the earphone is worn on the user's ear or not, based on the detection result of a proximity sensor.

If the wearing determination result indicates that the earphone is not worn on the ear, the storage unit 112 updates the stored authentication result.

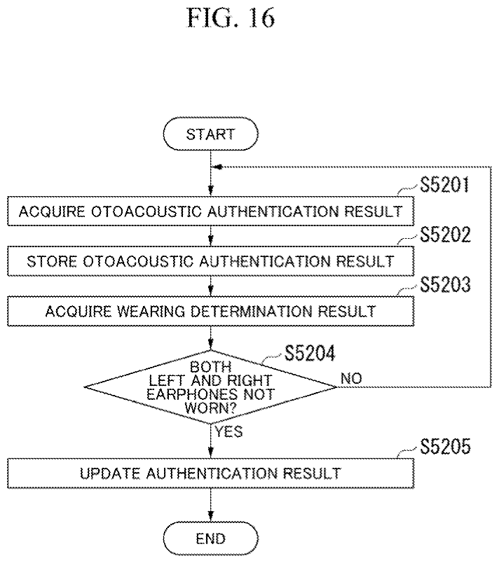

FIG. 16 is a flowchart showing the flow of processing in the minimal configuration example embodiment of the authentication system S in the present disclosure.

In Step S5201, the communication unit 113 (i.e., the acquisition unit) acquires the results of the user authentication by otoacoustic authentication in the earphone. The communication unit 113 advances the processing to Step S5202.

In Step S5202, the storage unit 112 stores the authentication result. The storage unit 112 advances the processing to Step S5203.

In Step S5203, after acquisition of the authentication result, the communication unit 113 (that is, the acquisition unit) acquires the wearing determination result, which indicates whether the earphone is worn on the user's ear or not, based on the detection result of the proximity sensor. The communication unit 113 advances the processing to Step S5204.

In Step S5204, if the wearing determination result indicates that both left and right earphones are not worn in the ears, the communication unit 113 advances the processing to Step S5205. If the wearing determination result does not indicate that both the left and right earphones are not worn in the ear, the communication unit 113 advances the processing to Step S5201.

In Step S5205, the storage unit 112 updates the stored authentication result. The storage unit 112 then ends the processing.

Some or all of the above example embodiments may also be described as in the following Supplementary Notes, but are not limited thereto.

### (Supplementary Note 1)

An authentication management device provided with: an authentication result acquisition means that acquires a result of authenticating a user by otoacoustic authentication in an earphone; a storage means that stores the authentication result; a determination result acquisition means that, after the authentication result is acquired, acquires a wearing determination result indicating whether the earphone is worn in an ear of the user on the basis of a detection result of a proximity sensor; and a control means that updates the authentication result stored in the storage means when the wearing determination result indicates that the earphone is not worn in the ear.

### (Supplementary Note 2)

The authentication management device according to Supplementary Note 1, wherein the otoacoustic authentication is an authentication method that sends out a test sound in the direction of the ear canal and authenticates the user on the basis of the sound reflected in response to the test sound.

### (Supplementary Note 3)

The authentication management device according to Supplementary Note 1 or 2, wherein in the determination result acquisition means, the determination as to whether or not the earphone is worn in the ear is performed periodically at each first predetermined period.

### (Supplementary Note 4)

The authentication management device according to any one of Supplementary Notes 1 to 3, wherein when it has been determined for a predetermined number of times or more during a second predetermined period that the earphone is not worn in the ear, the control means updates the authentication result stored in the storage means.

### (Supplementary Note 5)

The authentication management device according to Supplementary Note 3, further comprising an estimation means that estimates motion of the user,
wherein the first predetermined period is set based on the estimated motion of the user in the determination result acquisition means.

### (Supplementary Note 6)

The authentication management device according to Supplementary Note 4, further comprising an estimation means that estimates motion of the user,
wherein the second predetermined period is set based on the estimated motion of the user in the determination result acquisition means.

### (Supplementary Note 7)

An authentication method used in a computer, comprising:
an authentication result acquisition step that acquires a result of authenticating a user by otoacoustic authentication in an earphone;
a storage step that stores the authentication result;
a determination result acquisition step that, after the authentication result is acquired, acquires a wearing determination result indicating whether the earphone is worn in an ear of the user on the basis of a detection result of a proximity sensor; and
a control step that updates the authentication result stored in the storage means when the wearing determination result indicates that the earphone is not worn in the ear.

### (Supplementary Note 8)

A recording medium in which is recorded a program that causes a computer to execute:
an authentication result acquisition step that acquires a result of authenticating a user by otoacoustic authentication in an earphone;
a storage step that stores the authentication result;
a determination result acquisition step that, after the authentication result is acquired, acquires a wearing determination result indicating whether the earphone is worn in an ear of the user on the basis of a detection result of a proximity sensor; and
a control step that updates the authentication result stored in the storage means when the wearing determination result indicates that the earphone is not worn in the ear.

### DESCRIPTION OF REFERENCE SIGNS

1 Information communication device
2 Earphone
101, 201 CPU
102, 202 RAM
103, 203 ROM
104 HDD
105, 207 Communication IF
106 Input device
107 Output device
23 Speaker
24 Microphone
25 Proximity sensor
26 Motion sensor
204 Flash memory
205 Speaker IF
206 Microphone IF
208 Battery
209 Proximity sensor IF
210 Motion Sensor IF
111, 224 Determination unit
112, 225 Storage unit
113, 223 Communication unit
221 Measurement unit
222 Authentication unit

What is claimed is:

1. An authentication management device comprising:
at least one memory configured to store instructions; and
at least one processor configured to execute the instructions to:
acquire a result of authenticating a user by otoacoustic authentication in an earphone;
store the authentication result;
after the authentication result is acquired, acquire a wearing determination result indicating whether the earphone is worn in an ear of the user on the basis of a detection result of a proximity sensor; and
update the stored authentication result when the wearing determination result indicates that the earphone is not worn in the ear.

2. The authentication management device according to claim 1, wherein the otoacoustic authentication is an authentication method that sends out a test sound in the direction of the ear canal and authenticates the user on the basis of the sound reflected in response to the test sound.

3. The authentication management device according to claim 1, wherein the determination as to whether or not the earphone is worn in the ear is performed periodically at each first predetermined period.

4. The authentication management device according to claim 1, wherein when it is determined for a predetermined number of times or more during a second predetermined period that the earphone is not worn in the ear, the at least one processor is configured to execute the instructions to update the stored authentication result.

5. The authentication management device according to claim 3, wherein the at least one processor is configured to execute the instructions to estimate motion of the user,
wherein the first predetermined period is set based on the estimated motion of the user.

6. The authentication management device according to claim 4, wherein the at least one processor is configured to execute the instructions to estimate motion of the user,
wherein the second predetermined period is set based on the estimated motion of the user.

7. An authentication method used in a computer, comprising:
acquiring a result of authenticating a user by otoacoustic authentication in an earphone;
storing the authentication result;
after the authentication result is acquired, acquiring a wearing determination result indicating whether the earphone is worn in an ear of the user on the basis of a detection result of a proximity sensor; and
updating the stored authentication result when the wearing determination result indicates that the earphone is not worn in the ear.

8. A non-transitory recording medium in which is recorded a program that causes a computer to execute:
acquiring a result of authenticating a user by otoacoustic authentication in an earphone;
storing the authentication result;
after the authentication result is acquired, acquiring a wearing determination result indicating whether the earphone is worn in an ear of the user on the basis of a detection result of a proximity sensor; and
updating the stored authentication result when the wearing determination result indicates that the earphone is not worn in the ear.
